(19) United States
(12) Patent Application Publication
(10) Pub. No.: US 2017/0249436 A1
(43) Pub. Date: Aug. 31, 2017

(54) ULTRAVIOLET BASED DETECTION AND ANALYSIS

(71) Applicant: L'Oreal, Paris (FR)

(72) Inventors: Zane Bowman Allen Miller, Seattle, WA (US); Susan Halpern, Basking Ridge, NJ (US)

(73) Assignee: L'Oreal, Paris (FR)

(21) Appl. No.: 15/053,778

(22) Filed: Feb. 25, 2016

(51) Int. Cl. G06F 19/00

(52) U.S. Cl. CPC G06F 19/3431; G06F 19/326

(57) ABSTRACT

A system for recommending ultraviolet protection for a subject's skin includes an interrogation device, an analysis device, and an output device. The interrogation device has an ultraviolet sensitive module configured to generate interrogation data based on sensed electromagnetic energy reflected by the subject's skin in response to irradiation of the subject's skin by an ultraviolet electromagnetic energy source. The analysis device is configured to receive the interrogation data from the interrogation device and generate an ultraviolet analysis, which includes a recommendation for further ultraviolet protection of the subject's skin, based at least in part on the interrogation data. The output device receives the ultraviolet analysis and outputs the recommendation for further ultraviolet protection of the subject's skin.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one embodiment, a system for recommending ultraviolet protection for a subject's skin includes an interrogation device, an analysis device, and an output device. The interrogation device has an ultraviolet sensitive module and the ultraviolet sensitive module is configured to generate interrogation data based on sensed electromagnetic energy reflected by the subject's skin in response to irradiation of the subject's skin by an ultraviolet electromagnetic energy source. The analysis device is communicatively coupled to the interrogation device and configured to receive the interrogation data from the interrogation device. The analysis device is configured to generate an ultraviolet analysis based at least in part on the interrogation data, and the ultraviolet analysis includes at least a recommendation for further ultraviolet protection of the subject's skin. The output device is communicatively coupled to the analysis device and configured to receive the ultraviolet analysis and to output the recommendation for further ultraviolet protection of the subject's skin.

In one example, the electromagnetic energy source is included in the system and includes one or more of a UVA wavelength emitter array or a UVB wavelength emitter array. In another example, the electromagnetic energy source is configured to emit either a single wavelength based on an absorption peak of a specific filter or a plurality of wavelengths within an absorption spectrum. In another example, the electromagnetic energy source is direct sunlight. In another example, the ultraviolet sensitive module includes an ultraviolet sensitive camera and an ultraviolet band pass filter configured to filter wavelengths that are outside of a particular ultraviolet wavelength range. In another example, the ultraviolet sensitive module includes one or more ultraviolet wavelength sensors configured to sense one or more wavelengths of electromagnetic energy within a particular ultraviolet wavelength range.

In another example, the analysis device and the interrogation device are communicatively coupled via one or more of a wired connection or a short range wireless connection. In another example, the analysis device is located remotely from the interrogation device, and the analysis device and the interrogation device are communicatively coupled via one or more communication networks. In another example, the analysis device located remotely from the interrogation device is configured to store one or more of data about sensed electromagnetic energy of the subject's skin received from the interrogation device over a period of time covering more than one day or location data about the location of the subject received from the interrogation device over a period of time covering more than one day.

In another example, the recommendation for further ultraviolet protection of the subject's skin includes a recommended area of application of sunscreen on the subject's skin. In another example, the output device is configured to display an image of the subject's skin with the recommended area of application of sunscreen highlighted in a particular color.

In another example, the system further comprises a location data acquisition device configured to determine location data associated with one or more of the interrogation device or the analysis device. In another example, the analysis device is further configured to generate the ultraviolet analysis based at least in part on the location data. In another example, the analysis device is further configured to obtain weather data corresponding to the location data and to generate the ultraviolet analysis based at least in part on the weather data corresponding to the location data. In another example, the analysis device is further configured to maintain an ultraviolet exposure value for the subject based at least in part on the location data.

In another example, the recommendation for further ultraviolet protection of the subject's skin includes a recommended SPF value of sunscreen or clothing for further ultraviolet protection of the subject's skin. In another example, the recommendation for further ultraviolet protection of the subject's skin includes a timing recommendation for reapplying sunscreen or wearing additional clothing. In another example, the analysis device is configured to generate the timing recommendation based on one or more of a time of prior application of sunscreen, a type of activity engaged in by the subject, a location of the subject, or a desired skin tone of the subject.

In another embodiment, a method of recommending ultraviolet protection for a subject's skin includes receiving, by an analysis device from an interrogation device, interrogation data generated by an interrogation device, interrogation data based on sensed electromagnetic energy reflected by the subject's skin or clothing over the subject's skin in response to irradiation of the subject's skin or the clothing over the subject's skin by an ultraviolet electromagnetic energy source; generating, by the analysis device, an ultraviolet analysis based at least in part on the interrogation data, wherein the ultraviolet analysis includes at least a recommendation for further ultraviolet protection of the subject's skin; and sending, by the analysis device, the ultraviolet analysis with the recommendation for further ultraviolet protection of the subject's skin to an output device, wherein the output device is configured to receive the ultraviolet analysis and to output the recommendation for further ultraviolet protection of the subject's skin.

In one example, generating the ultraviolet analysis includes one or more of assigning an SPF rating of the current ultraviolet protection based on the interrogation data, analyzing ultraviolet protection relative to current ultraviolet exposure based on a query of a weather or historical exposure database, or analyzing ultraviolet protection relative to current ultraviolet exposure based on a location of the interrogation device. In another example, generating the ultraviolet analysis includes generating the recommendation for further ultraviolet protection of the subject's skin based on one or more of an analysis of current protection based on the interrogation data, an analysis of local exposure data based on the interrogation data, estimated lifetime ultraviolet exposure values based at least on the interrogation data, or medical recommendations for the subject based on estimated lifetime ultraviolet exposure values.

### DESCRIPTION OF THE DRAWINGS

The foregoing aspects and many of the attendant advantages of the disclosed subject matter will become more readily appreciated as the same become better understood by reference to the following detailed description, when taken in conjunction with the accompanying drawings, wherein:

FIGS. 1A to 1C depict an embodiment of an interrogation device that includes an ultraviolet sensitive module, in accordance with embodiments disclosed herein;

FIGS. 2A to 2C depict embodiments of an interrogation device communicatively coupled to an analysis device, in accordance with embodiments disclosed herein;

FIG. 3 depicts an embodiment of an interaction between an interrogation device and an analysis device, in accordance with embodiments disclosed herein;

FIGS. 4A to 4C depict examples of various types of images of a subject;

FIG. 5 depicts an embodiment of presenting a subject with both a visible light image and a recommendation for further ultraviolet protection of the subject's skin;

FIGS. 6A and 6B depict embodiments of non-image-based recommendations in the form of spectral absorption charts, in accordance with embodiments disclosed herein;

FIGS. 7A and 7B depict embodiments of non-image-based recommendations in the form of efficacy percentages, in accordance with embodiments disclosed herein;

FIGS. 8A and 8B depict embodiments of systems that include an interrogation device, an analysis device, a communication network, and a remote computing device, in accordance with embodiments disclosed herein;

FIG. 8C depict another embodiment of a system that includes an interrogation device, a communication network, and a remote computing device, in accordance with embodiments disclosed herein;

FIGS. 9A and 9B depict another embodiment of an interrogation device communicatively couplable to an analysis device, in accordance with embodiments disclosed herein.

### DETAILED DESCRIPTION

The detailed description set forth below in connection with the appended drawings where like numerals reference like elements is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

With instances of skin cancer and other skin-related afflictions increasing, awareness about skin protection has also been increasing. Skin protection often comes in the form of skin covering, such as clothing and accessories (e.g., hats), and skin treatments, such as sunscreen. Skin protection can limit or prevent harm to skin from certain kinds of exposure, such as exposure to ultraviolet (UV) electromagnetic energy (e.g., sunlight), which has a wavelength in a range from 10 nm to 400 nm. However, many individuals do not understand the coverage and strength of their chosen form(s) of skin protection, and remain vulnerable to exposure when they believe that they are protected.

Many individuals have difficulty verifying coverage and strength of skin treatments, such as sunscreen. Because most sunscreens are not visible when they are applied, it is difficult for individuals to discern between areas of their skin where sunscreen has been applied and areas of their skin where sunscreen has not been applied. In addition, certain types of sunscreen applicators give the illusions of proper and complete coverage when there is in fact little to no coverage. For example, spray sunscreen applicators often give users the impression that spraying alone provides complete coverage, when the sprayed sunscreen does not provide proper exposure until it is worked into the skin by hand. Areas of missed or limited skin treatment coverage can result in immediate effects, such as sunburns in the exposed areas, and the long-term effects, such as additional exposure to UV electromagnetic energy which increases a possibility of developing skin cancer as well as prematurely aging the skin and creating areas of hyperpigmentation.

Another issue with skin treatments is the deterioration of the skin treatment effectiveness over time. The rate at which the effectiveness of skin treatment deteriorates varies based on a number of factors. These factors include one or more of the degradation of electromagnetic radiation filters in the skin treatment either before or after application, wearing away of the skin treatment from certain activities (e.g., swimming, etc.), and physiological effects of the person on whom the skin treatment has been applied (e.g., sweat, body temperature, etc.). A person that has applied a skin treatment typically is unable to detect the effectiveness of the skin treatment at the time of application or any time thereafter. Thus, the person typically does not know whether and when to apply additional skin treatment to ensure sufficient protection.

Another problem with existing skin treatments is that ratings of skin treatments are imperfect measurements. In the United States, sunscreen skin treatments are given an SPF (“sun protection factor”) value. The SPF value is intended as a measure of the fraction of sunburn-producing UV rays that reach the skin (e.g., “SPF 30” indicates that 1/30 of sunburn-producing UV rays reach the skin). However, this reading is imprecise for a number of reasons. In one example, the amount of exposure to UV rays that produces sunburns varies from individual to individual. In another example, the amount of protection provided by any skin treatment varies based on the amount and uniformity of application of the skin treatment to the skin. In another example, visible skin damage is typically caused by UV radiation type A (UVA), which has a wavelength in the range of 315 nm to 400 nm, and SPF values are based on visible damage caused to skin. However, nonvisible damage to skin is caused by exposure to other sources of electromagnetic radiation, such as UV radiation type B (UVB), which has a wavelength in the range of 280 nm to 315 nm, other UV electromagnetic radiation, or non-UV electromagnetic radiation. Thus, some skin treatments may have high SPF values, indicating that they protect well against UVA, while offering little to no protection from UVB or other forms of electromagnetic radiation.

Another problem with skin protection from skin coverings is that individuals may not know the different levels of protection offered by different skin coverings. In some embodiments, certain color fabrics offer more protection from certain forms of electromagnetic radiation. For example, a dark-colored fabric (e.g., black fabric) may offer more protection from UV electromagnetic radiation than a light-colored fabric (e.g., white fabric). In some embodiments, certain types of fabric may offer more protection from certain forms of electromagnetic radiation. For example, a heavy fabric (e.g., wool) may offer more protection from UV electromagnetic radiation than a light fabric (e.g., cotton). Moreover, even when skin coverings prevent individuals from being sunburned, it is not apparent whether the same skin coverings protect individuals from skin-harming electromagnetic radiation that does not cause sunburns (e.g., UVB electromagnetic radiation).

Based on these considerations, there is a need for aiding individuals in understanding their exposure to skin-harming electromagnetic radiation. This understanding may include one or more of understanding a current level of protection from skin-harming electromagnetic radiation, understanding a rate at which the level of protection is degrading, understanding an expected time at which skin protection should be adjusted or reapplied, understanding an exposure to skin-harming electromagnetic radiation over a period of time, or any other understanding of the state or effect of skin-harming electromagnetic radiation. Such an understanding that may be presented to a user may be aided by an interrogation device, an analysis device, and an output device, as described in greater detail herein.

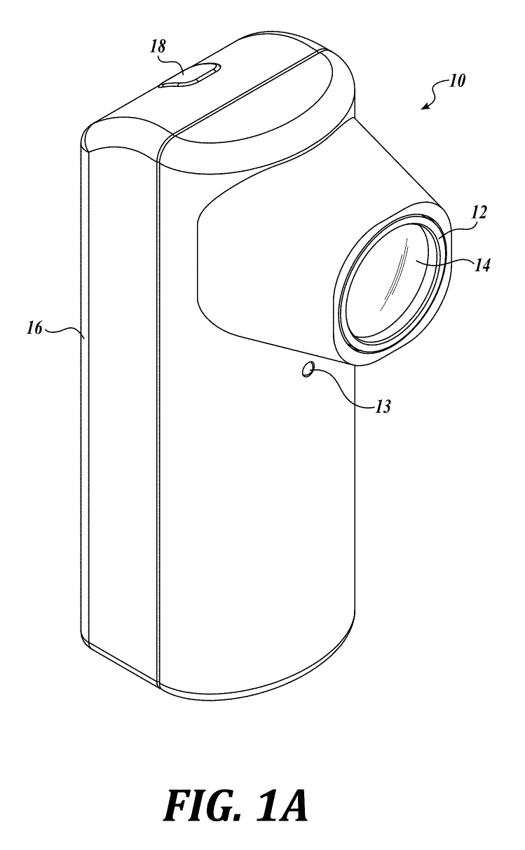

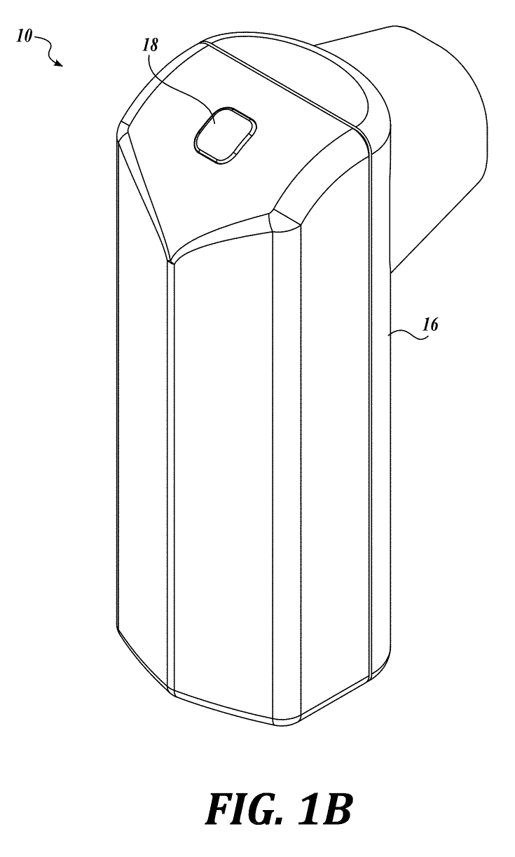

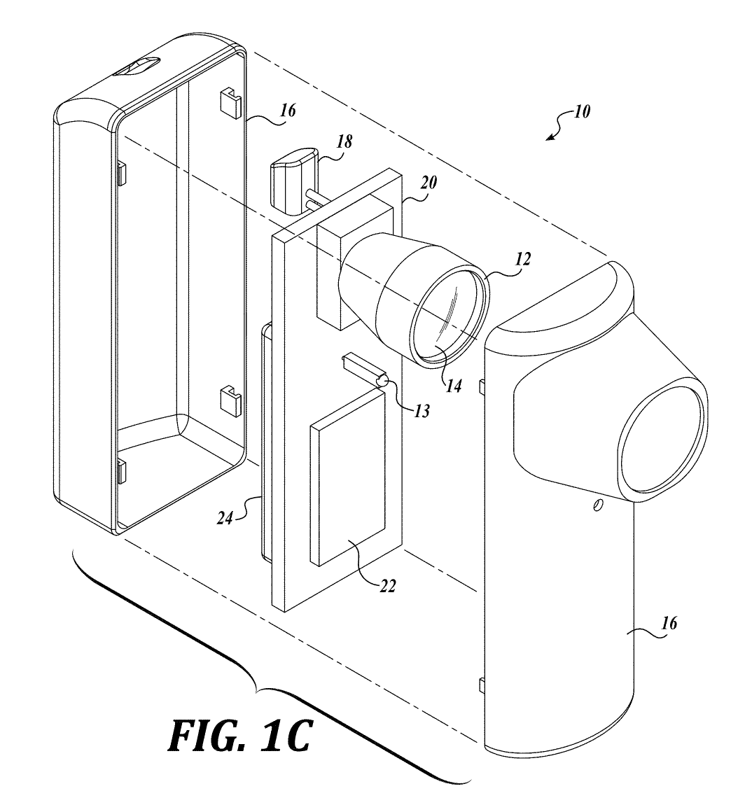

FIGS. 1A, 1B, and 1C depict, respectively, front, side, and exploded views of an embodiment of an interrogation device 10. The interrogating device 10 includes an ultraviolet sensitive module 12. The ultraviolet sensitive module 12 is configured to sense electromagnetic energy reflected by a subject's skin in response to irradiation of the subject's skin by an ultraviolet electromagnetic energy source. In one example, the ultraviolet sensitive module 12 is configured to sense electromagnetic energy reflected by a subject's skin in response to irradiation of the subject's skin by a natural electromagnetic energy source, such as sunlight. In another example, the ultraviolet sensitive module 12 is configured to sense electromagnetic energy reflected by a subject's skin in response to irradiation of the subject's skin by an artificial electromagnetic energy source, such as electromagnetic energy source 13 included in the interrogation device 10.

The electromagnetic energy source 13 can take a number of forms. In some examples, the electromagnetic energy source 13 includes one or more of a UVA wavelength emitter array or a UVB wavelength emitter array. In one example, the electromagnetic energy source 13 includes one or more Group III-nitride blue LED solid state emitters that are capable of emitting electromagnetic radiation at wavelengths in a range spanning from ultraviolet to blue visible light. In some examples, the number of individual UVA wavelength emitters in the electromagnetic energy source 13 (e.g., the number of LEDs) is in a range from one UVA wavelength emitter to one hundred UVA wavelength emitters.

In one embodiment, the wavelength output of electromagnetic energy source 13 is selected based on a desired response from a particular area of skin. In one example, the wavelength output of the electromagnetic energy source 13 includes one or more gallium-indium-nitrogen (GaInN) LEDs that have a wavelength output of about 360-370 nm. Such a wavelength output approximates the wavelength output a Wood's lamp examination tool (about 365 nm). In other embodiments, the electromagnetic energy source 13 emits electromagnetic energy in a range of wavelengths from about 10 nm to about 400 nm. In some embodiments, the electromagnetic energy source 13 is configured to emit either a single wavelength based on an absorption peak of a specific filter (e.g., 350 nm) or a plurality of wavelengths within an absorption spectrum (e.g., a plurality of wavelengths between about 10 nm and about 400 nm).

In some embodiments, the ultraviolet sensitive module 12 includes an electromagnetic energy sensor, such as a charge-coupled device (CCD) camera or a complementary metal-oxide-semiconductor (CMOS) camera. In an embodiment, the ultraviolet sensitive module 12 is configured to detect (e.g., sense, measure, assess, and the like) electromagnetic radiation, such as visible light (having a wavelength in a range from 400 nm to 700 nm), infrared electromagnetic radiation (having a wavelength in a range from 700 nm to 1 mm), UV electromagnetic radiation, and the like. For example, in an embodiment, the ultraviolet sensitive module 12 includes one or more of optical sensors (e.g., charged couple device (CCD) array), optical waveguide sensors, electromagnetic energy sensors, UV sensors, complementary metal-oxide semiconductor (CMOS) sensors, and the like.

Various features of image sensors are well-known to one of ordinary skill in the art and will not be discussed in detail here. In some embodiments, the ultraviolet sensitive module 12 includes one or more ultraviolet wavelength sensors configured to sense one or more wavelengths of electromagnetic energy within a particular ultraviolet wavelength range.

In some embodiments, the ultraviolet sensitive module 12 is configured to generate interrogation data based on the sensed electromagnetic energy (e.g., the electromagnetic energy reflected by the subject's skin in response to irradiation of the subject's skin by the ultraviolet electromagnetic energy source). Representative interrogation data includes data about absorbance of electromagnetic energy, reflectance of electromagnetic energy, wavelengths of electromagnetic energy, and the like. In one example, the interrogation data is determined from image data of one or more pixels generated by the ultraviolet sensitive module 12. In other examples, the interrogation data is determined from one or more of a direct wavelength measurement or a measurement and the interrogation data is output as one or more colors in a color model (e.g., the RGB [red, green, blue] color model, the CMY [cyan, magenta, yellow] or CMYK [cyan, magenta, yellow, black] color space, and the like).

In some embodiments, including the one depicted in FIGS. 1A to 1C, the interrogation device 10 includes a filter 14 configured to selectively filter electromagnetic energy of particular wavelengths. In one example, the filter 14 is configured to selectively block wavelengths of electromagnetic energy outside of the range from about 10 nm to about 400 nm such that most or all of the electromagnetic energy reaching the ultraviolet sensitive module 12 is UV electromagnetic radiation. In other embodiments, the interrogation device 10 includes a digital filter configured to filter the interrogation data generated by the ultraviolet sensitive module 12, such as filtering out interrogation data that is unrelated to detection of UV electromagnetic energy so that the filtered interrogation data is representative of the UV electromagnetic energy detected by the UV sensitive module 12.

In some embodiments, the electromagnetic energy reflected by the subject's skin in response to irradiation of the subject's skin by the UV electromagnetic energy source is UV electromagnetic energy. In such a case, the UV sensitive module 12 is configured to sense UV electromagnetic energy. In one example, the filter 14 is configured to filter out electromagnetic energy that is not in the UV electromagnetic energy so that UV electromagnetic energy is received by the UV sensitive module 12. In one embodiment, the ultraviolet sensitive module 12 includes an ultraviolet sensitive camera and the filter 14 is an ultraviolet band-pass filter configured to filter wavelengths that are outside of a particular ultraviolet wavelength range (e.g., outside of a range between about 260 nm and about 400 nm). In other embodiments, the electromagnetic energy reflected by the subject's skin in response to irradiation of the subject's skin by the UV electromagnetic energy source is outside of the UV electromagnetic energy range. For example, one or more materials in skin may fluoresce at a wavelength outside of the UV electromagnetic energy range in response to the irradiation by the UV electromagnetic energy source. In such cases, the UV sensitive module 12 is configured to sense electromagnetic energy outside of the UV electromagnetic energy range.

In the embodiment shown in FIGS. 1A to 1C, the interrogation device 10 includes a housing 16 that forms a handle. The handle increases convenience for a user to use the interrogation device 10. In one embodiment, the housing 16 houses additional components of the interrogation device 10. As shown in FIGS. 1A to 1C, the housing 16 provides an opening for a power switch 18 configured to permit a user to toggle power to the interrogation device 10 and an opening for the electromagnetic energy source 13. As shown in FIG. 1C, the housing 16 houses a printed circuit board 20 that includes the electromagnetic energy source 13, the power switch 18, a wireless communication device 22 and a power source 24 (e.g., rechargeable battery). In other embodiments, the housing 16 houses an electrical connection usable to recharge the power source 24, user input mechanisms other than the power switch 18, indicators and/or displays, and the like.

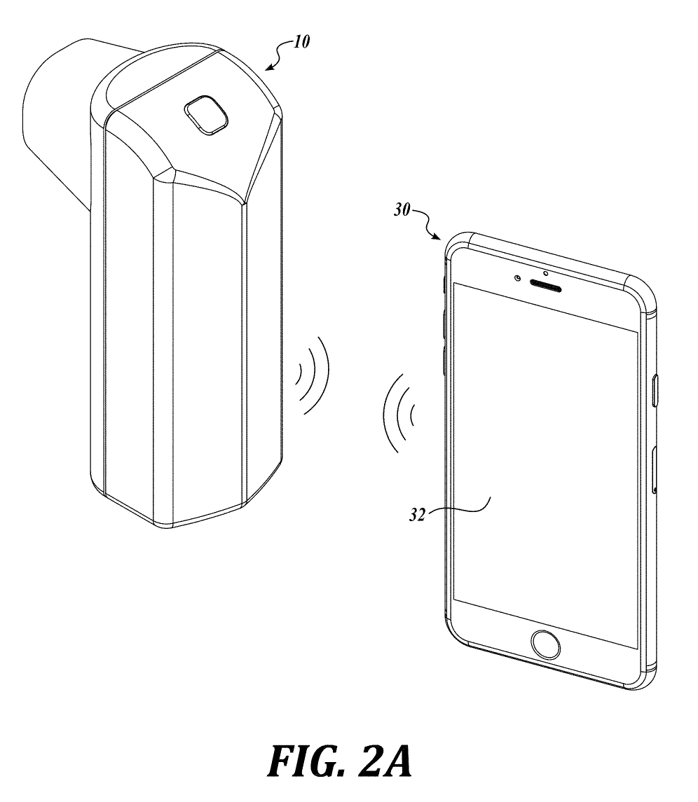

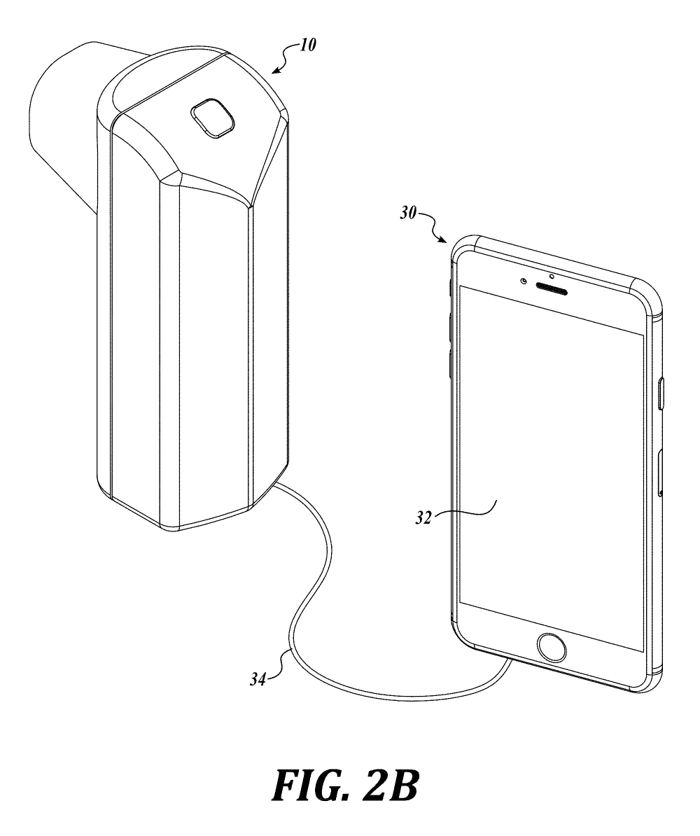

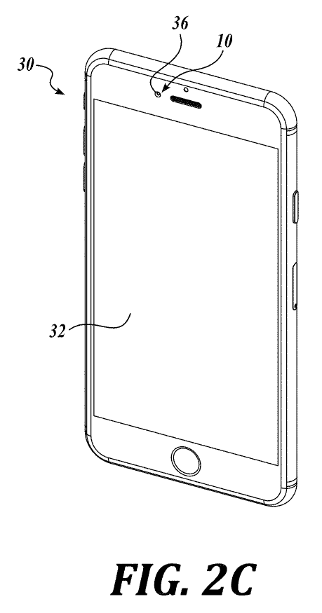

The embodiments of the interrogation device 10 depicted herein are configured to communicate with an analysis device 30. Depicted in FIGS. 2A to 2C are examples of the interrogation device 10 communicatively coupled to the analysis device 30. In FIGS. 2A to 2C, the analysis device 30 is depicted as a cell phone; however, in other examples, the analysis device 30 takes the form of any number of other computing devices, such as a server, a desktop computer, a laptop computer, a tablet computer, and the like. In the depicted embodiments, the analysis device 30 includes an output device 32 in the form of an integrated display. In other embodiments, the output device 32 is a monitor coupled to the analysis device 30, a speaker coupled to the analysis device 30, or any other device configured to produce an output.

In FIG. 2A, the interrogation device 10 is communicatively coupled to the analysis device 30 via a wireless connection. In some embodiments, the wireless connection is a direct wireless connection, such as a Bluetooth connection, a near field communication (NFC) connection, a direct WiFi connection, or any other direct wireless connection. In some embodiments, the wireless connection is an indirect connection via one or more wireless networks, such as a cellular network (e.g., 4G, LTE), a WiFi network, a local area network, any other network, or any combination thereof. In some embodiments, the wireless connection permits the analysis device 30 to be located remotely from the interrogation device 10.

In FIG. 2B, the interrogation device 10 is communicatively coupled to the analysis device 30 via a wired connection in the form of a cable 34. In some embodiments, the wired connection permits serial and/or bus communication between the interrogation device 10 and the analysis device 30, such as a universal serial bus (USB) connection. In some embodiments not depicted in FIGS. 2A and 2B, the interrogation device 10 is communicatively coupled to the analysis device 30 via a combination of wired and wireless connections. In one example, the interrogation device 10 is coupled to the a WiFi access point via a wireless WiFi connection and the WiFi access point is coupled to the analysis device 30 via a wired LAN connection.

Depicted in FIG. 2C is the interrogation device 10 integrated into the analysis device 30. In the particular embodiment, the interrogation device 10 is in the form of a forward-facing camera 36 on the analysis device 30. In other examples, the interrogation device 10 is a rearward-facing camera on the analysis device 30. In another example, the interrogation device 10 is a UV-sensing device separate from a forward-facing and/or rearward-facing visible light camera on the analysis device 30. In some embodiments, where the interrogation device 10 is integrated into the analysis device 30, as shown in FIG. 2C, the interrogation device 10 is communicatively coupled to the analysis device 30 via internal wiring or circuitry in the analysis device 30.

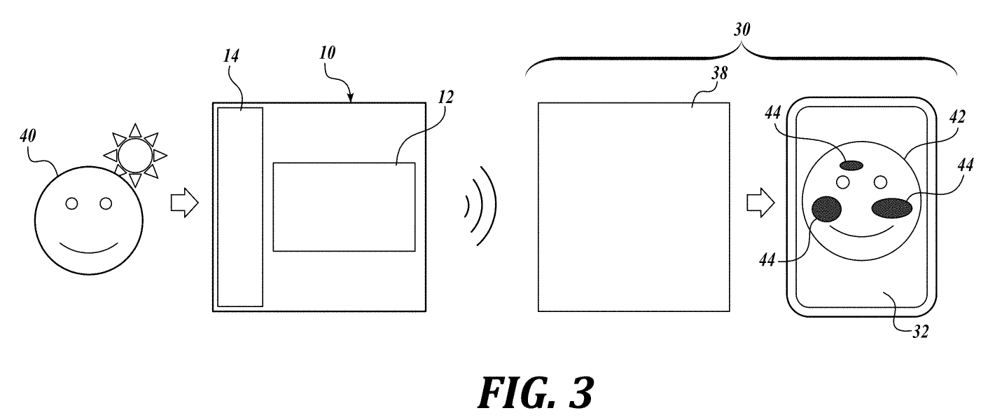

An example of an interaction between the interrogation device 10 and the analysis device 30 is depicted in FIG. 3. The interrogation device 10 includes the ultraviolet sensitive module 12. The skin of a subject 40 is irradiated by a UV electromagnetic energy source (e.g., sunlight). The ultraviolet sensitive module 12 is configured to generate interrogation data based on sensed electromagnetic energy reflected by the skin of the subject 40 in response to irradiation by the UV electromagnetic energy source. In the depicted embodiment, the interrogation device 10 includes a filter 14 configured to permit a wavelength or a range of wavelengths of electromagnetic energy to reach the ultraviolet sensitive module 12.

In an embodiment, during operation, the analysis device 30 receives interrogation data from the interrogation device 10. The analysis device 30 is configured to generate an ultraviolet analysis based at least in part on the interrogation data. In the depicted embodiment, the analysis device 30 includes an application 38 configured to generate the ultraviolet analysis. In some embodiments, the application 38 is configured to perform image processing on the interrogation data to generate the ultraviolet analysis. The ultraviolet analysis includes a recommendation for further ultraviolet protection of the skin of the subject 40. As discussed in greater detail below, in some examples, the recommendation for further ultraviolet protection includes one or more of an indication of an area of the subject 40 that is lacking UV protection, an indication of a recommended area of application of sunscreen on the skin of the subject 40, a recommended SPF value of sunscreen or clothing for further ultraviolet protection of the skin of the subject 40, a timing recommendation for reapplying sunscreen or wearing additional clothing, or any other recommendation.

In the depicted embodiment, the analysis device 30 includes an output device 32 in the form of a display. The output device 32 is communicatively coupled to the other components of the analysis device 30 (e.g., a processor executing instructions to operate the application 38). The output device 32 is configured to receive the ultraviolet analysis and to output the recommendation for further ultraviolet protection of the skin of the subject 40. In an embodiment, the output device 32 is configured to indicate, via one or more of a visual, audio, haptic, or a tactile representation, the ultraviolet protection status of a user, ultraviolet protection recommendation information, exposures information, sunscreen coverage information, or the like. In the particular embodiment depicted in FIG. 3, the output device 32 outputs an image 42 representative of the subject 40 and the recommendation, which includes an indication of recommended areas 44 of application of sunscreen on the skin of the subject 40. In another embodiment, an image representative of a subject is depicted with areas indicating which areas of the subject have been covered by sunscreen. Other examples of outputting the recommendation for further ultraviolet protection of the skin of the subject 40 are described below.

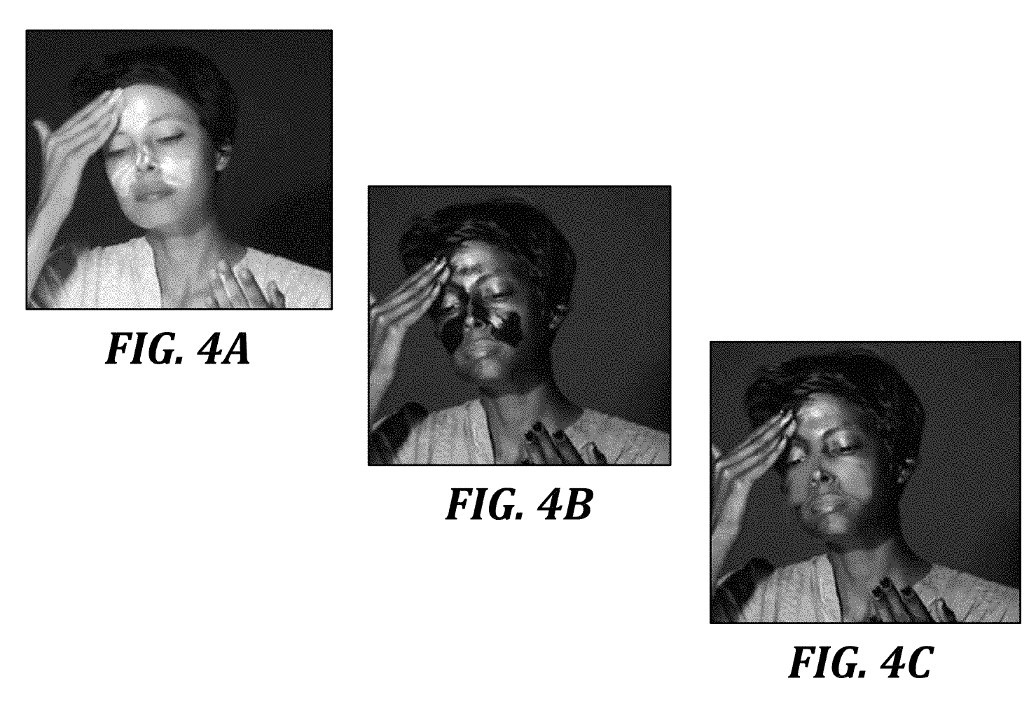

Examples of images of a subject are depicted in FIGS. 4A to 4C. A visible light image of a subject applying sunscreen is depicted in FIG. 4A. As shown in that image, it may be difficult to differentiate between areas where sunscreen has been applied and areas where sunscreen has not been applied using a visible light image of the subject. An image taken of the subject with a UV band-pass filter is depicted in FIG. 4B. As shown, the areas of the subject's skin that are protected by sunscreen (or any other form of UV protection) are more prominent in the UV band-pass filtered image than the visible light image. In some embodiments, the image depicted in FIG. 4B is representative of the interrogation data generated by the interrogation device 10. An example of a processed version of the UV band-pass filtered image is shown in FIG. 4C. In this particular example, the image processing has converted the areas of the subject covered by UV protection into areas of a highlighted color that allows the subject to more easily see the areas covered by the UV protection. In some embodiments, the image depicted in FIG. 4C is representative of the ultraviolet analysis generated by the analysis device 30 (e.g., by the application 38) and the image depicted in FIG. 4C can be displayed by an output device 32 to provide a recommendation for further ultraviolet protection of the subject's skin (e.g., the areas of the subject's skin not covered by the highlighted color).

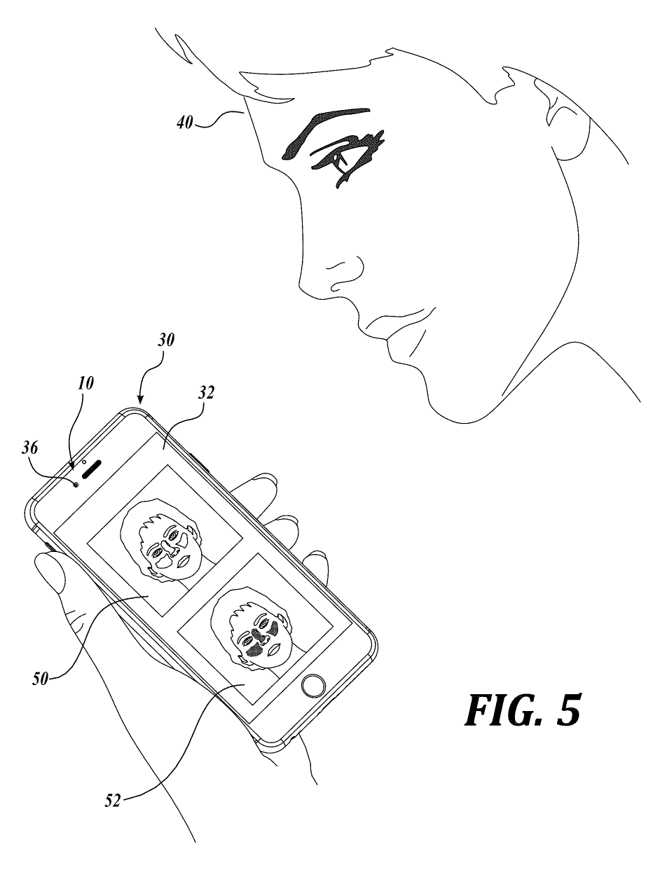

One embodiment of presenting a subject with both a visible light image and a recommendation for further ultraviolet protection of the subject's skin is depicted in FIG. 5. In this embodiment, the interrogation device 10 is integrated into the analysis device 30 and is in the form of a user-facing camera 36 on the analysis device 30. The interrogation device 10 is configured to generate interrogation data based on sensed electromagnetic energy reflected by the skin of the subject 40 in response to irradiation of the skin of the subject 40 by an ultraviolet electromagnetic energy source. The analysis device 30 receives the interrogation data from the interrogation device 10, and the analysis device 30 generates an ultraviolet analysis, including at least a recommendation for further ultraviolet protection of the subject's skin, based at least in part on the interrogation data.

The analysis device 30 includes the output device 32 in the form of a display. The output device 32 displays a first image 50 and a second image 52. In the depicted embodiment, the first image 50 is a visible light image of the subject 40 taken by the interrogation device 10 or another imaging device (e.g., camera) on the analysis device 30. The second image 52 is a recommendation image, such as a processed version of either the visible light image or a UV band-pass filtered image. In the particular recommended image shown in FIG. 5, the output device 32 outputs a recommendation for further ultraviolet protection of the skin of the subject 40 by highlighting areas of the skin of the subject 40 that are protected by UV protection (e.g., sunscreen).

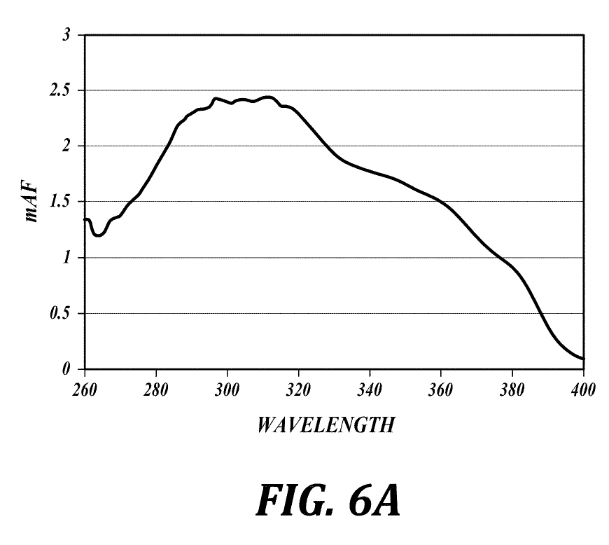

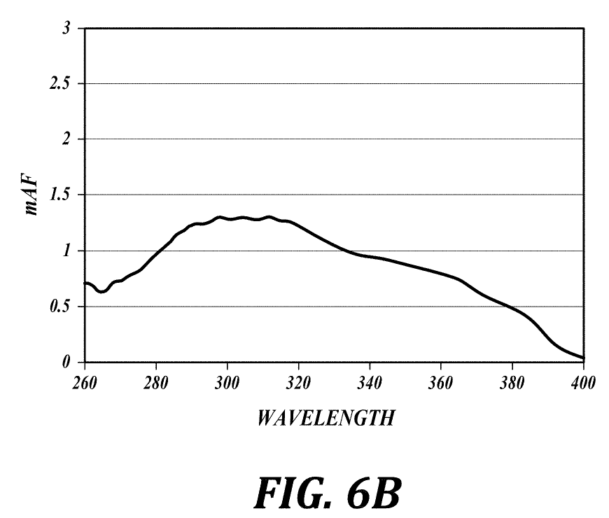

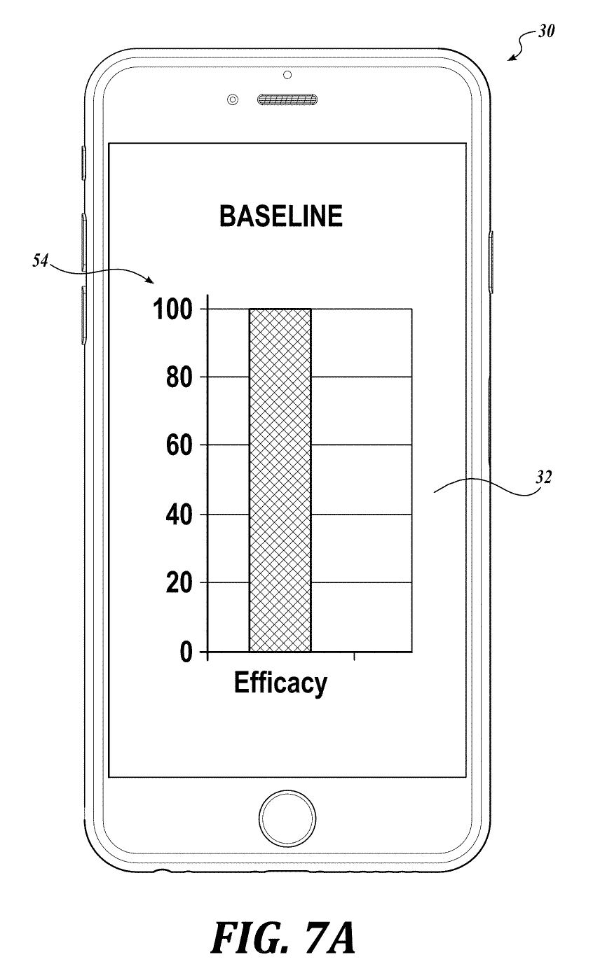

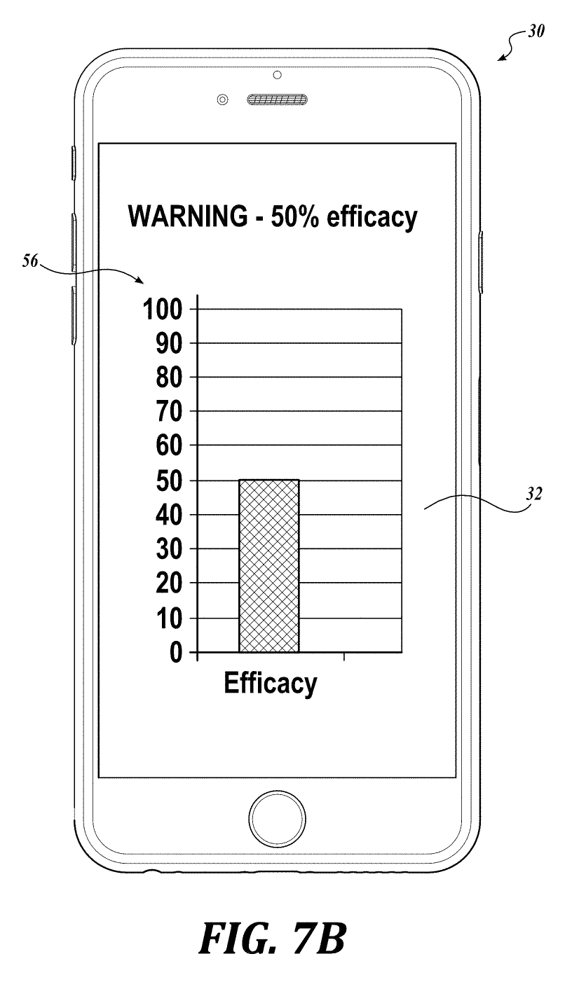

While many of the recommendations for further ultraviolet protection shown above have been image-based recommendations, other non-image-based recommendations can be presented to a user. Some examples of non-image recommendations are depicted in FIGS. 6A and 6B, in the form of spectral absorption charts, and in FIGS. 7A and 7B, in the form of efficacy percentages.

In FIGS. 6A and 6B, the spectral absorption charts show data for spectral absorption of UV light in a range from about 260 nm to about 400 nm by a target (e.g., the subject's skin). In some embodiments, the first spectral absorption chart in FIG. 6A depicts UV absorption by the subject's skin at a first point in time and the second spectral absorption chart in FIG. 6B depicts UV absorption by the subject's skin at a second point in time.

In one embodiment, the data shown in the first spectral absorption chart is determined soon after application of UV protection and the data for the first spectral absorption chart is a baseline set of data. Over time, the UV protection decreases (e.g., when the subject swims, sweats, etc.) to the point shown in the second spectral absorption chart. The UV protection at any current moment can be compared to the baseline data as an indication of how effective the UV protection is at that moment. For example, the two sets of data shown in FIGS. 6A and 6B can be overlaid on the same chart and output via an output device to provide the subject with an indication of how effective the UV protection is at the current moment. In such a case, the difference between the two sets of data shown in FIGS. 6A and 6B overlaid on each other in the same chart is a recommendation to the subject about further UV protection that is needed to bring the UV protection up to the baseline. In other cases, the output device may further provide a curve on the chart indicating a point at which it is further recommended that UV protection be applied.

In another embodiment, the data shown in the first and second spectral absorption charts is compared to a predetermined set of baseline data for typical UV protection. For example, a curve indicating ideal UV protection (e.g., for a particular brand of sunscreen, a particular SPF rating for sunscreen, etc.) can be overlaid on one or both of the charts in FIGS. 6A and 6B and output via an output device to provide the subject with an indication of how effective the UV protection is at the two different times.

In FIGS. 7A and 7B, efficacy percentages 54 and 56 of UV protection are shown on an output device 32 of an analysis device 30. Specifically, the efficacy percentage 54 in FIG. 7A indicates that, at that point in time, the level of UV protection is approximately 100% of the baseline UV protection. In some examples, the baseline UV protection is either a measured level of UV protection (e.g., at a time soon after UV protection is first applied) or a predetermined set of baseline data for typical UV protection (e.g., an expected baseline for a particular brand of sunscreen, an expected baseline for a particular SPF rating for sunscreen, etc.).

The efficacy percentage 56 in FIG. 7B indicates that, at that point in time, the level of UV protection is approximately 50% of the baseline UV protection. In the embodiment shown in FIG. 7B, the efficacy percentage 56 also includes a warning about the efficacy percentage 56. In some embodiments, the efficacy percentage 56 is based on one or more of a measurement of UV protection using the interrogation device 10 or an estimated level of decreased protection since application of UV protection (e.g., based on one or more of weather at a location of the analysis device 30, an activity of the subject since application of UV protection, time since application of the UV protection, etc.).

In some embodiments, the efficacy percentages 54 and 56 in FIGS. 7A and 7B are based on the data of spectral absorption shown in the charts in FIGS. 6A and 6B. In other embodiments, other recommendations for further UV protection of the subject's skin are based on the data of spectral absorption shown in the charts in FIGS. 6A and 6B or other similar data. In one example, the output device may output a timer indicative of an expected time that UV protection is recommended to be reapplied. Such a timer may be an audio output (e.g., an alarm sound) at the time that the UV protection is recommended to be reapplied.

In an embodiment, the interrogation device 10 includes circuitry configured to generate recommendations about changes to the subject's form of UV protection. In one example, the analysis device 30 is configured to compare the current UV protection of a subject to a predetermined level of protection. For example, if UV protection in the form of sunscreen is applied to the subject, and the subject's measured level of UV protection is below the predetermined level of protection, the recommendation may include a recommendation to increase the level of SPF used by the subject. In another example, if UV protection in the form of clothing is worn by the subject, and the subject's measured level of UV protection is below the predetermined level of protection, the recommendation may include a recommendation to change clothing worn by the subject to a darker color of clothing. In another example, the skin tone of the subject's skin may be compared to a desired skin tone (e.g., a desired level of tan), and a recommended SPF value can be provided to the subject via the output device 32.

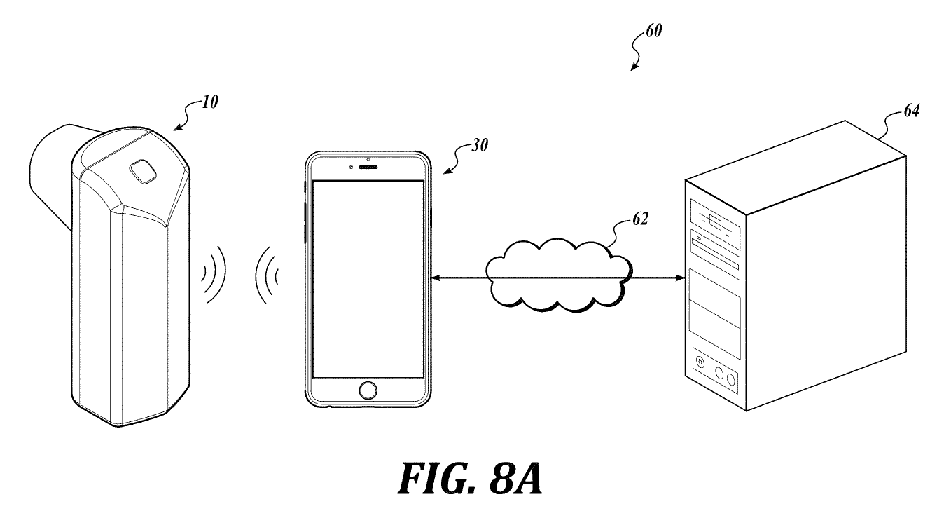

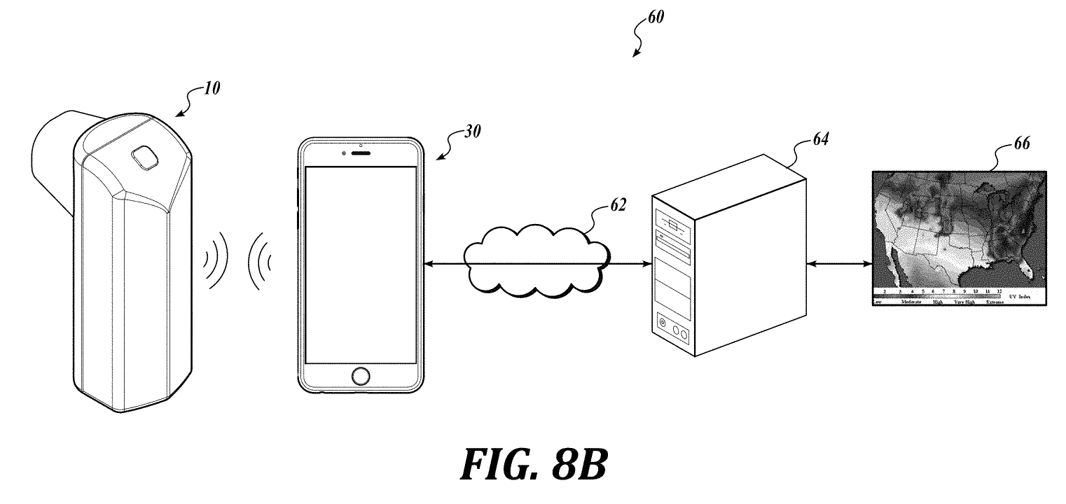

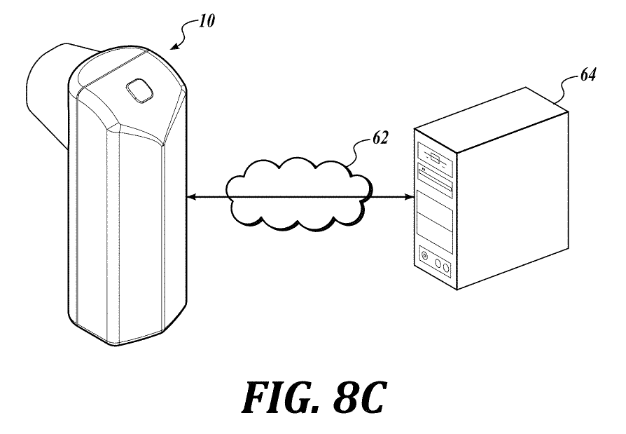

In some embodiments described herein, the analysis device 30 is configured to communicate with a remote computing device. For example, during operation, in an embodiment, the analysis device 30 is configured to implement a discovery protocol that allows the analysis device 30 and a remote client device to find each other and negotiate one or more pre-shared keys. Depicted in FIGS. 8A and 8B are embodiments of systems 60 that include the interrogation device 10, the analysis device 30, a communication network 62, and a remote computing device 64 (e.g., a server). In some embodiments, the communication network 62 includes one or more of a cellular network (e.g., 4G, LTE), a WiFi network, a local area network, any other network, or any combination thereof.

In FIG. 8A, the analysis device 30 is configured to send data to the remote computing device 64 via the communication network 62. In some embodiments, analysis device 30 receives interrogation data from the interrogation device 10. In some embodiments, the analysis device 30 sends the interrogation data to the remote computing device 64 via the communication network 62. In other embodiments, after the analysis device 30 generates the ultraviolet analysis from the interrogation data, the analysis device 30 sends the ultraviolet analysis to the remote computing device 64 via the communication network 62. In some embodiments, the analysis device 30 sends other data, such as location data about the analysis device 30, atmospheric data taken by the analysis device 30 (e.g., temperature, humidity, etc.), or any other data. In some embodiments where the analysis device 30 sends location data, the analysis device 30 includes a location data acquisition device (e.g., a global positioning system (GPS) device) configured to determine location data associated with one or more of the interrogation device 10 or the analysis device 30.

In some embodiments, the remote computing device 64 is configured to maintain information about UV exposure to particular subjects over time. For example, in an embodiment, the remote computing device 64 is configured to maintain user-specific lifetime UV exposure information. In one example, the remote computing device 64 maintains information about actual measured interrogation data about the subject sent to the remote computing device 64 from the analysis device 30. At times when actual measurement data is not available, such as when the analysis device 30 does not provide interrogation data about the subject, the remote computing device 64 may estimate an amount of UV exposure for the subject. Such an estimate may be based on the location of the analysis device 30 (e.g., whether the subject is indoors or outdoors), a speed of the analysis device 30 (e.g., whether the subject is outside or in a vehicle), the atmospheric data near the analysis device 30, or any other type of data. Over time, the remote computing device 64 may compile an estimated UV exposure level for a particular subject. Any estimated UV exposure level for a particular subject bay be useful to the subject in determining whether to limit UV exposure in the future, to medical providers in determining whether the subject is at increased risk for particular conditions (e.g., skin cancer), to insurance providers to better assess the risk of the subject's future medical conditions, and the like.

In the embodiment shown in FIG. 8B, the remote computing device 64 is in communication with a weather database 66. In some embodiments, the weather database 66 is stored locally on the remote computing device 64. In other embodiments, the weather database 66 is located remotely (e.g., the National Climactic Data Center database). In some embodiments, the weather database 66 includes historical data about particular locations and the remote computing device 64 is configured to determine atmospheric data of locations of the analysis device 30 over time. Such information about atmospheric data of locations of the analysis device 30 over time may increase the accuracy of any estimates about UV exposure to a subject in the absence of actual measured data.

Another embodiment of a system that includes the interrogation device 10, the communication network 62, and the remote computing device 64 is depicted in FIG. 8C. As depicted, the interrogation device 10 is configured to communicate with the computing device 64 via the communication network 62. In this embodiment, the interrogation device 10 sends interrogation data to the remote computing device 64 via the communication network 62. The remote computing device 64 operates as an analysis device to receive the interrogation data from the interrogation device and generate an ultraviolet analysis, including at least a recommendation for further ultraviolet protection of the subject's skin, based at least in part on the interrogation data. The remote computing device 64 is configured to send the ultraviolet analysis to an output device associated with the interrogation device 10. In one embodiment, the interrogation device 10 includes an output device (e.g., a display or a speaker) which is configured to output the recommendation for further ultraviolet protection of the subject's skin.

The configuration in FIG. 8C allows for the analysis device (e.g., remote computing device 64) to be located remotely from the interrogation device 10. In such a case, the analysis device (e.g., remote computing device 64) is configured to store one or more of data about sensed electromagnetic energy of the subject's skin received from the interrogation device over a period of time covering more than one day or location data about the location of the subject received from the interrogation device over a period of time covering more than one day.

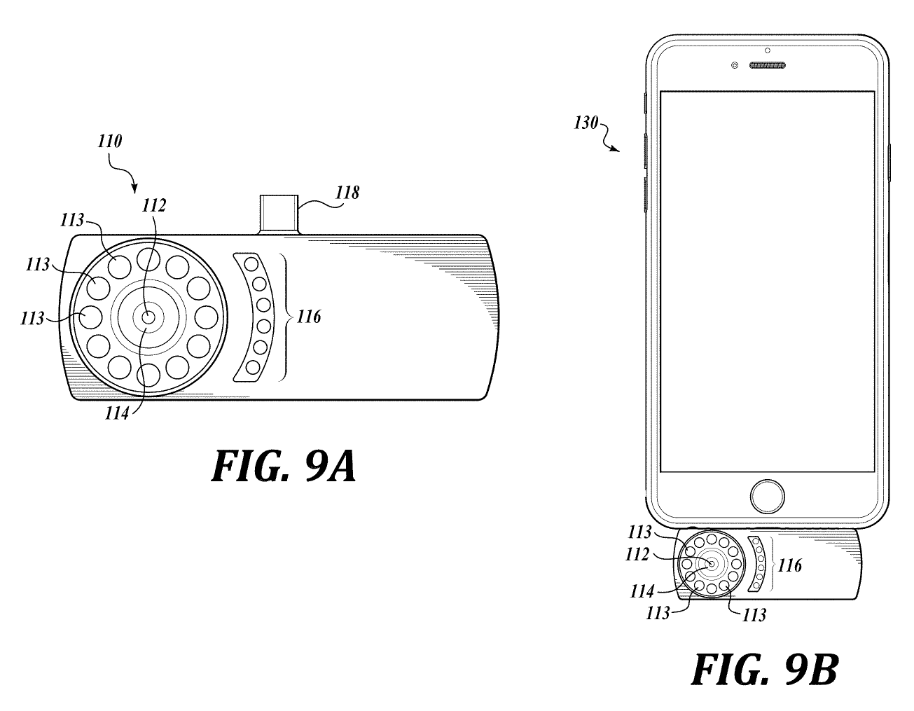

Another embodiment of an interrogation device 110 is depicted in FIGS. 9A and 9B. The interrogation device 110 includes an ultraviolet sensitive module 12 that is configured to sense electromagnetic energy reflected by a subject's skin in response to irradiation of the subject's skin by an ultraviolet electromagnetic energy source. The interrogation device 110 also includes an electromagnetic energy source 113. In the depicted embodiment, the electromagnetic energy source 113 is a ring of UV LEDs. In some embodiments, the interrogation device 110 also includes a filter 114 configured to selectively filter electromagnetic energy of particular wavelengths. In the depicted embodiment, the interrogation device 110 includes an array of sensors 116 configured to generate spectral absorption data associated with spectral absorption of UV light in a range from about 260 nm to about 400 nm. In some embodiments, sensors in the array of sensors 116 are ultraviolet wavelength sensors configured to sense one or more wavelengths of electromagnetic energy within a particular ultraviolet wavelength range. Such spectral absorption data is usable in generating spectral absorption reports (e.g., the spectral absorption charts shown in FIGS. 6A and 6B.

As shown in FIG. 9A, the depicted embodiment of the interrogation device 110 includes a connector 118. The connector is configured to be coupled to an analysis device 130. An example of the interrogation device 110 coupled to the analysis device 130 is depicted in FIG. 9B. In some embodiments, the analysis device 130 includes a mating connector (not shown) configured to receive the connector 118 to couple the interrogation device 110 to the analysis device 130 and to establish a wired connection between the interrogation device 110 and the analysis device 130. In some embodiments, the connection between the connector 118 and the mating connector on the analysis device 130 is configured to pass power from the analysis device 130 to the interrogation device 110 or vice versa.

While illustrative embodiments have been illustrated and described, it will be appreciated that various changes can be made therein without departing from the spirit and scope of the claimed subject matter.

The detailed description set forth herein in connection with the drawings is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

The embodiments of the invention in which an exclusive property or privilege is claimed are defined as follows:

1. A system for recommending ultraviolet protection for a subject's skin, the system comprising:
an interrogation device having an ultraviolet sensitive module, wherein the ultraviolet sensitive module is configured to generate interrogation data based on sensed electromagnetic energy reflected by the subject's skin in response to irradiation of the subject's skin by an ultraviolet electromagnetic energy source;
an analysis device communicatively coupled to the interrogation device and configured to receive the interrogation data from the interrogation device, wherein the analysis device is configured to generate an ultraviolet analysis based at least in part on the interrogation data, wherein the ultraviolet analysis includes at least a recommendation for further ultraviolet protection of the subject's skin; and
an output device communicatively coupled to the analysis device and configured to receive the ultraviolet analysis and to output the recommendation for further ultraviolet protection of the subject's skin.

2. The system of claim 1, wherein the electromagnetic energy source is included in the system and includes one or more of a UVA wavelength emitter array or a UVB wavelength emitter array.

3. The system of claim 1, wherein the electromagnetic energy source is configured to emit either a single wavelength based on an absorption peak of a specific filter or a plurality of wavelengths within an absorption spectrum.

4. The system of claim 1, wherein the electromagnetic energy source is direct sunlight.

5. The system of claim 1, wherein the ultraviolet sensitive module includes an ultraviolet sensitive camera and an ultraviolet band-pass filter configured to filter wavelengths that are outside of a particular ultraviolet wavelength range.

6. The system of claim 1, wherein the ultraviolet sensitive module includes one or more ultraviolet wavelength sensors configured to sense one or more wavelengths of electromagnetic energy within a particular ultraviolet wavelength range.

7. The system of claim 1, wherein the analysis device and the interrogation device are communicatively coupled via one or more of a wired connection or a short range wireless connection.

8. The system of claim 1, wherein the analysis device is located remotely from the interrogation device, and wherein the analysis device and the interrogation device are communicatively coupled via one or more communication networks.

9. The system of claim 8, wherein the analysis device located remotely from the interrogation device is configured to store one or more of data about sensed electromagnetic energy of the subject's skin received from the interrogation device over a period of time covering more than one day or location data about the location of the subject received from the interrogation device over a period of time covering more than one day.

10. The system of claim 1, wherein the recommendation for further ultraviolet protection of the subject's skin includes a recommended area of application of sunscreen on the subject's skin.

11. The system of claim 10, wherein the output device is configured to display an image of the subject's skin with the recommended area of application of sunscreen highlighted in a particular color.

12. The system of claim 1, wherein the system further comprises a location data acquisition device configured to determine location data associated with one or more of the interrogation device or the analysis device.

13. The system of claim 12, wherein the analysis device is further configured to generate the ultraviolet analysis based at least in part on the location data.

14. The system of claim 12, wherein the analysis device is further configured to obtain weather data corresponding to the location data and to generate the ultraviolet analysis based at least in part on the weather data corresponding to the location data.

15. The system of claim 12, wherein the analysis device is further configured to maintain an ultraviolet exposure value for the subject based at least in part on the location data.

16. The system of claim 1, wherein the recommendation for further ultraviolet protection of the subject's skin includes a recommended SPF value of sunscreen or clothing for further ultraviolet protection of the subject's skin.

17. The system of claim 1, wherein the recommendation for further ultraviolet protection of the subject's skin includes a timing recommendation for reapplying sunscreen or wearing additional clothing.

18. The system of claim 1, wherein the analysis device is configured to generate the timing recommendation based on one or more of a time of prior application of sunscreen, a type of activity engaged in by the subject, a location of the subject, or a desired skin tone of the subject.

19. A method of recommending ultraviolet protection for a subject's skin, the system comprising:
receiving, by an analysis device from an interrogation device, interrogation data generated by an interrogation device, interrogation data based on sensed electromagnetic energy reflected by the subject's skin or clothing over the subject's skin in response to irradiation of the subject's skin or the clothing over the subject's skin by an ultraviolet electromagnetic energy source;
generating, by the analysis device, an ultraviolet analysis based at least in part on the interrogation data, wherein the ultraviolet analysis includes at least a recommendation for further ultraviolet protection of the subject's skin; and
sending, by the analysis device, the ultraviolet analysis with the recommendation for further ultraviolet protection of the subject's skin to an output device, wherein the output device is configured to receive the ultraviolet analysis and to output the recommendation for further ultraviolet protection of the subject's skin.

20. The method of claim 19, wherein generating the ultraviolet analysis includes one or more of assigning an SPF rating of the current ultraviolet protection based on the interrogation data, analyzing ultraviolet protection relative to current ultraviolet exposure based on a query of a weather or historical exposure database, or analyzing ultraviolet protection relative to current ultraviolet exposure based on a location of the interrogation device.

21. The method of claim 19, wherein generating the ultraviolet analysis includes generating the recommendation for further ultraviolet protection of the subject's skin based on one or more of an analysis of current protection based on the interrogation data, an analysis of local exposure data based on the interrogation data, estimated lifetime ultraviolet exposure values based at least on the interrogation data, or medical recommendations for the subject based on estimated lifetime ultraviolet exposure values.
